(19) United States
(12) Patent Application Publication
(10) Pub. No.: US 2018/0079636 A1
(43) Pub. Date: Mar. 22, 2018

(54) Forklift Safety System

(71) Applicants: Warren Dixon, Alabaster, AL (US); Brad Killingsworth, Alabaster, AL (US)

(72) Inventors: Warren Dixon, Alabaster, AL (US); Brad Killingsworth, Alabaster, AL (US)

(21) Appl. No.: 15/272,896

(22) Filed: Sep. 22, 2016

(51) Int. Cl. B66F 17/00; B66F 9/07; B66F 9/075

(52) U.S. Cl. CPC B66F 17/003; B66F 9/075; B66F 9/07

(57) ABSTRACT

A forklift safety system includes a forklift each of the forks extending away from the front side. A barrier unit is movably coupled to the forklift. The barrier unit is selectively positioned in a deployed position. Thus, the barrier unit inhibits the forks from being walked across thereby reducing a tripping hazard. The barrier unit is selectively positioned in a stored position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for inhibiting a person from tripping on forks of a forklift.

### BRIEF SUMMARY OF THE INVENTION

An embodiment of the disclosure meets the needs presented above by generally comprising a forklift each of the forks extending away from the front side. A barrier unit is movably coupled to the forklift. The barrier unit is selectively positioned in a deployed position. Thus, the barrier unit inhibits the forks from being walked across thereby reducing a tripping hazard. The barrier unit is selectively positioned in a stored position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a barrier unit of a forklift safety system according to an embodiment of the disclosure.

FIG. 2 is a perspective in-use view of an embodiment of the disclosure.

FIG. 3 is a left side view of an embodiment of the disclosure.

FIG. 4 is a top view of an embodiment of the disclosure.

FIG. 5 is a perspective view of an alternative embodiment of an embodiment of the disclosure.

FIG. 6 is a top perspective in-use view of an embodiment of the disclosure.

### DETAILED DESCRIPTION OF THE INVENTION

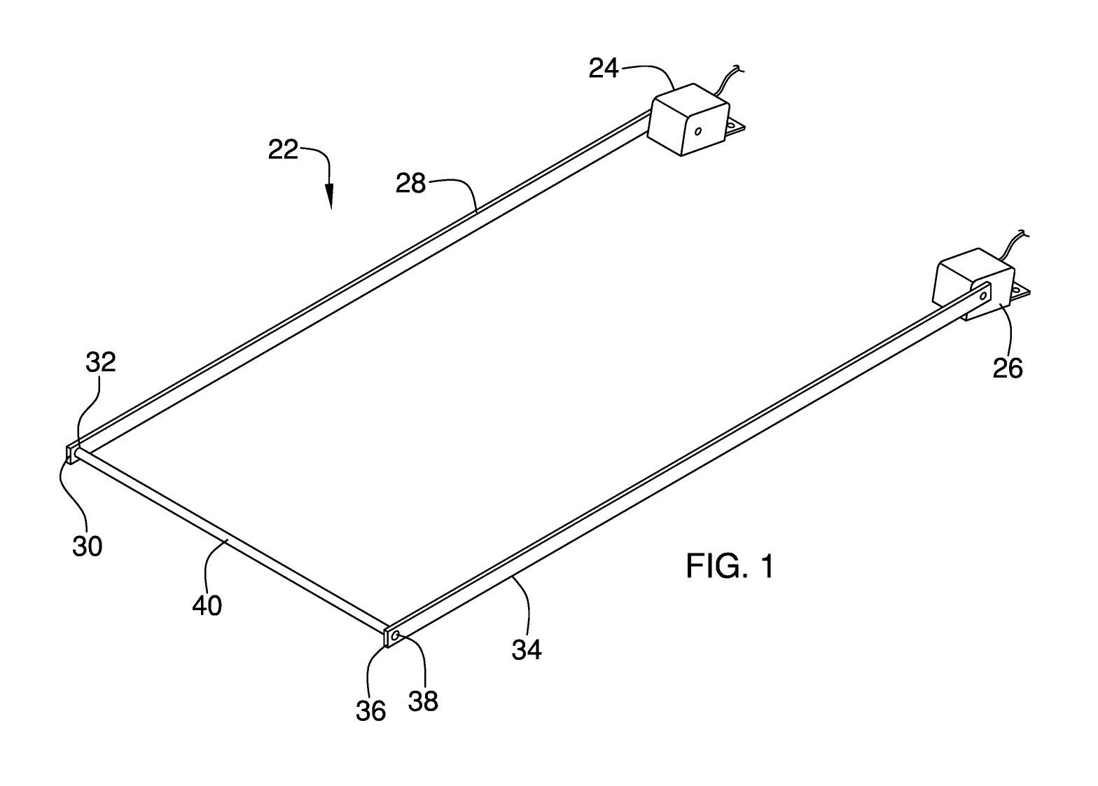

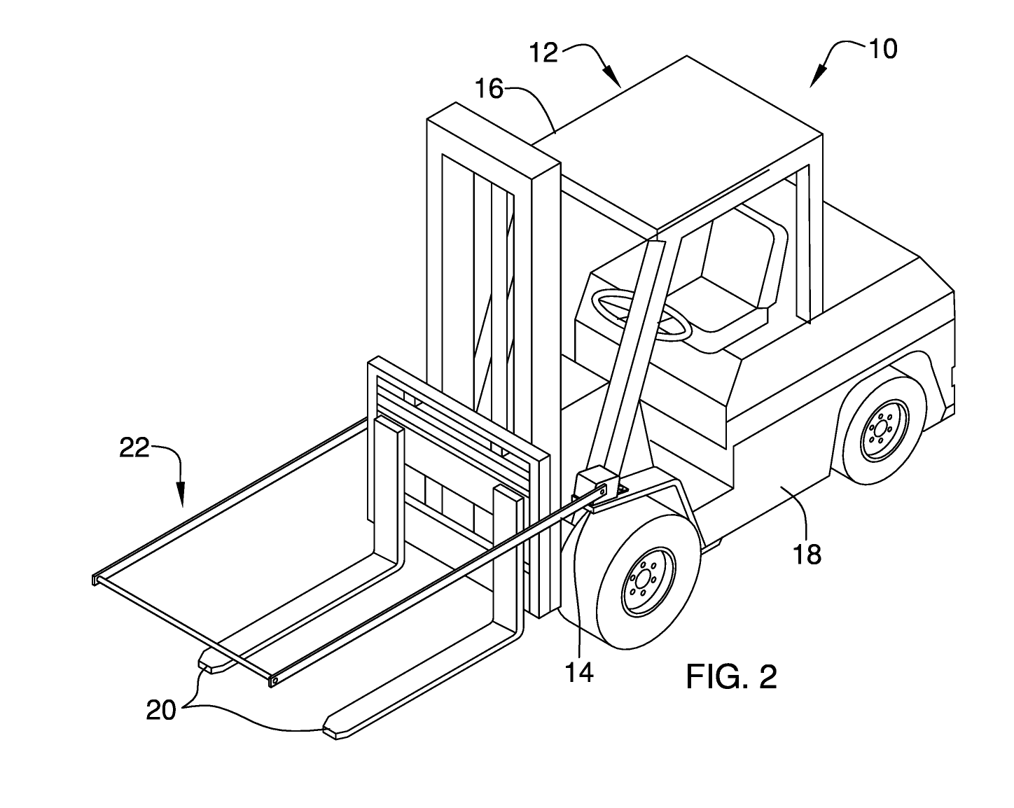

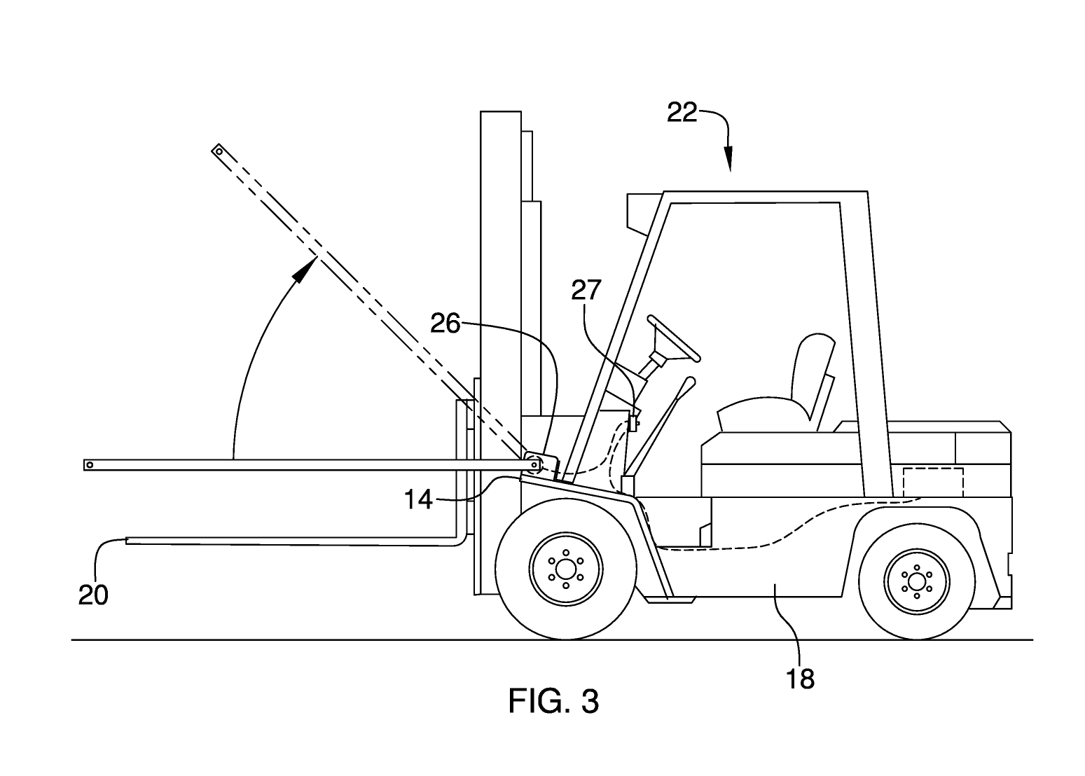

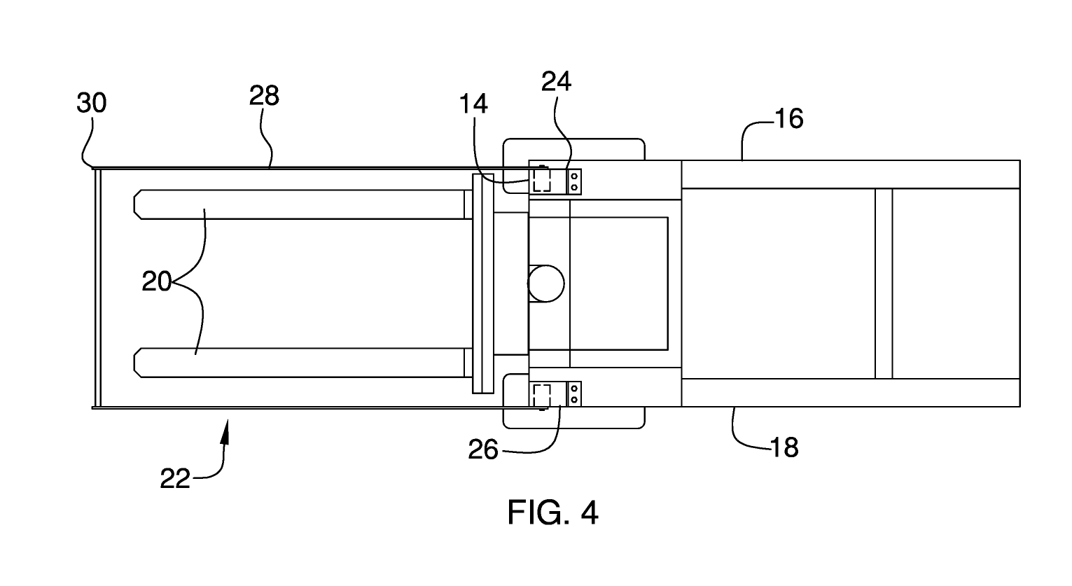

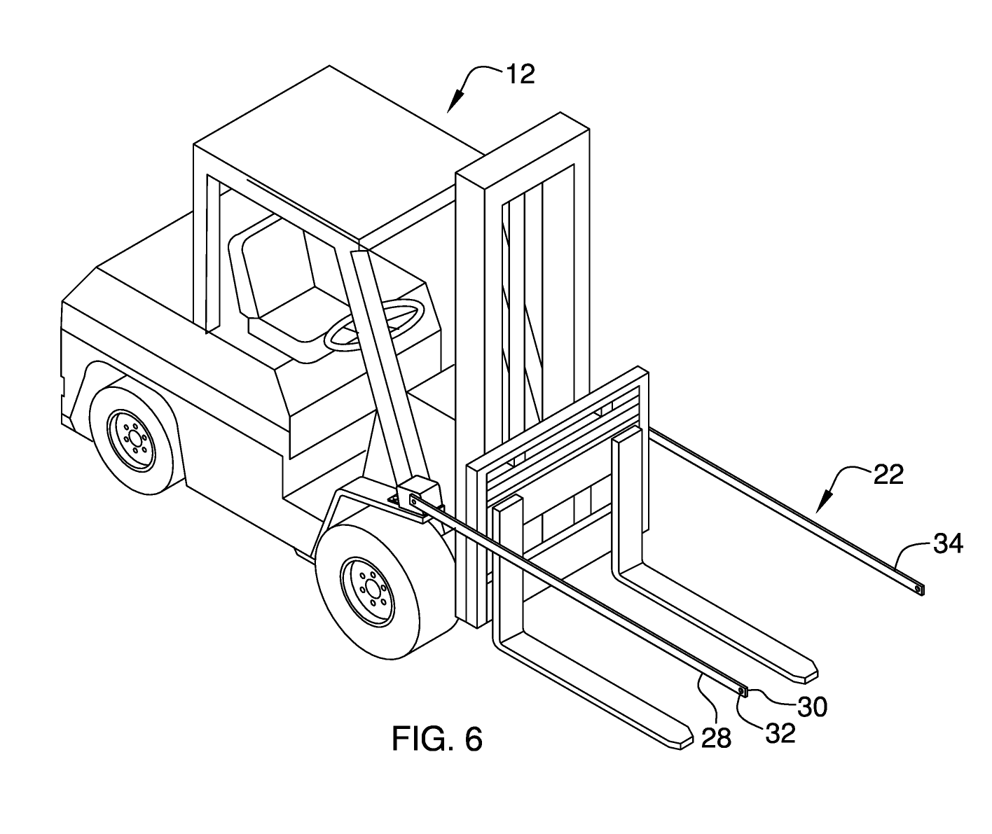

With reference now to the drawings, and in particular to FIGS. 1 through 6 thereof, a new safety device embodying the principles and concepts of an embodiment of the disclosure and generally designated by the reference numeral 10 will be described.

As best illustrated in FIGS. 1 through 6, the forklift safety system 10 generally comprises a forklift 12 that has a front side 14, a first lateral side 16 and a second lateral side 18. The forklift 12 has a pair of forks 20 and each of the forks 20 extends away from the front side 14. The forklift 12 may be an electric forklift, an engine powered forklift or any powered forklift.

A barrier unit 22 is provided. The barrier unit 22 is movably coupled to the forklift 12. The barrier unit 22 is selectively positioned in a deployed position. Thus, the barrier unit 22 inhibits the forks 20 from being walked across thereby reducing a tripping hazard. The barrier unit 22 is selectively positioned in a stored position.

The barrier unit 22 comprises a first actuator 24 that is coupled to the forklift 12. The first actuator 24 is positioned at an intersection of the front side 14 and the first lateral side 16 of the forklift 12. The first actuator 24 is electrically coupled to the forklift 12. The first actuator 24 may comprise an electric motor or a hydraulic motor. Additionally, the first actuator 24 may include a shaft that rotates in a first direction and a second direction.

A second actuator 26 is provided and the second actuator 26 is coupled to the forklift 12. The second actuator 26 is positioned at an intersection of the front side 14 and the second lateral side 18 of the forklift 12. The second actuator 26 is electrically coupled to the forklift 12. The second actuator 26 may comprise an electric motor or a hydraulic motor. Moreover, the second actuator 26 may include a shaft that rotates in a first direction and a second direction.

A switch 27 is provided. The switch 27 is coupled to the forklift 12 and the switch 27 may be manipulated. The switch 27 is electrically coupled to each of the first actuator 24 and the second actuator 26. The switch 27 is electrically coupled to the forklift 12.

A first member 28 is provided. The first member 28 is coupled to the first actuator 24. The first member 28 may be attached to the shaft corresponding to the first actuator 24. The first member 28 has a distal end 30 with respect to the first actuator 24.

The first member 28 is spaced from and is coextensive with the pair of forks 20 when the barrier unit 22 is in the deployed position. Thus, the first member 28 inhibits a person from walking across the forks 20. The first member 28 extends upwardly from the forklift 12 when the barrier unit 22 is positioned in the stored position. The first member 28 has an opening 32 extending therethrough and the opening 32 is aligned with the distal end 30.

A second member 34 is provided. The second member 34 is coupled to the second actuator 26. The second member 34 may be attached to the shaft corresponding to the second actuator 26. The second member 34 has a distal end 36 with respect to the second actuator 26.

The second member 34 is spaced from and is coextensive with the pair of forks 20 when the barrier unit 22 is in the deployed position. Thus, the second member 34 inhibits a person from walking across the forks 20. The second member 34 extends upwardly from the forklift 12 when the barrier unit 22 is positioned in the stored position. The second member 34 has an aperture 38 extending therethrough. The aperture 38 is aligned with the distal end 36 of the second member 34.

A rod 40 is provided. The rod 40 is removably coupled between the distal end 30 of the first member 28 and the distal end 36 of the second member 34. The rod 40 is extended through the opening 32 and the aperture 38.

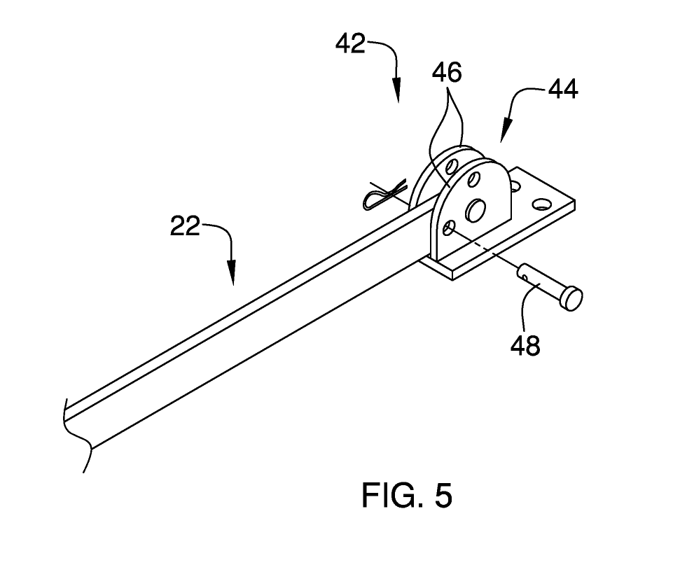

In an alternative embodiment 42 as shown in FIG. 5, a mount 44 may be provided. The mount 44 may include a pair of spaced plates 46. The mount 44 may be coupled to the forklift 12. The barrier unit 22 may be hingedly coupled to the mount 44. A pin 48 may be provided and the pin 48 may extended between the pair of spaced plates 46 and the barrier unit 22. Thus, the barrier unit 22 is retained in the deployed position and the stored position.

In use, each of the first actuator 24 and the second actuator 26 are selectively turned on to position the first 28 and second 34 members in the stored position. Thus, the forklift 12 is manipulated in the convention of forklift 12 usage when the first 28 and second 34 members are positioned in the stored position. Each of the first actuator 24 and the second actuator 26 are selectively turned on the position the first 28 and second 34 members in the deployed position. The forklift 12 is parked. The first 28 and second 34 members inhibit a person from walking across the forks 20.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A forklift safety system comprising:
a forklift; and
a barrier unit being movably coupled to said forklift, said barrier unit being selectively positioned in a deployed position wherein said barrier unit is configured to inhibit said forks from being walked across thereby reducing a tripping hazard, said barrier unit being selectively positioned in a stored position.

2. The system according to claim 1, wherein:
said forklift has a front side and a first lateral side; and
said barrier unit comprises a first actuator being coupled to said forklift, said first actuator being positioned at an intersection of said front side and said first lateral side of said forklift, said first actuator being electrically coupled to said forklift.

3. The system according to claim 1, further comprising:
said forklift having a front side and a second lateral side; and
a second actuator being coupled to said forklift, said second actuator being positioned at an intersection of said front side and said second lateral side of said forklift, said second actuator being electrically coupled to said forklift.

4. The system according to claim 2, further comprising a first member being coupled to said first actuator, said first member having a distal end with respect to said first actuator, said first member being spaced from and being coextensive with said pair of forks when said barrier unit is in said deployed position, said first member extending upwardly from said forklift when said barrier unit is positioned in said stored position.

5. The system according to claim 4, wherein said first member has an opening extending therethrough, said opening being aligned with said distal end.

6. The system according to claim 3, further comprising a second member being coupled to said second actuator, said second member having a distal end with respect to said second actuator, said second member being spaced from and being coextensive with said pair of forks when said barrier unit is in said deployed position, said second member extending upwardly from said forklift when said barrier unit is positioned in said stored position.

7. The system according to claim 6, wherein said second member has an aperture extending therethrough, said aperture being aligned with said distal end of said second member.

8. The system according to claim 7, further comprising:
a first rod having an opening; and
a rod being removably coupled between said distal end of said first member and said distal end of said second member, said rod being extended through said opening and said aperture.

9. A forklift safety system comprising:
a forklift having a front side, a first lateral side and a second lateral side, said forklift having a pair of forks, each of said forks extending away from said front side; and
a barrier unit being movably coupled to said forklift, said barrier unit being selectively positioned in a deployed position wherein said barrier unit is configured to inhibit said forks from being walked across thereby reducing a tripping hazard, said barrier unit being selectively positioned in a stored position, said barrier unit comprising:
a first actuator being coupled to said forklift, said first actuator being positioned at an intersection of said front side and said first lateral side of said forklift, said first actuator being electrically coupled to said forklift,
a second actuator being coupled to said forklift, said second actuator being positioned at an intersection of said front side and said second lateral side of said forklift, said second actuator being electrically coupled to said forklift,
a first member being coupled to said first actuator, said first member having a distal end with respect to said first actuator, said first member being spaced from and being coextensive with said pair of forks when said barrier unit is in said deployed position, said first member extending upwardly from said forklift when said barrier unit is positioned in said stored position, said first member having an opening extending therethrough, said opening being aligned with said distal end,
a second member being coupled to said second actuator, said second member having a distal end with respect to said second actuator, said second member being spaced from and being coextensive with said pair of forks when said barrier unit is in said deployed position, said second member extending upwardly from said forklift when said barrier unit is positioned in said stored position, said second member having an aperture extending therethrough, said aperture being aligned with said distal end of said second member, and
a rod being removably coupled between said distal end of said first member and said distal end of said second member, said rod being extended through said opening and said aperture.
